(19) United States
(12) Patent Application Publication
(10) Pub. No.: US 2011/0085042 A1
(43) Pub. Date: Apr. 14, 2011

(54) SYSTEM AND METHOD FOR CAMERA ARRAY CONTROL

(75) Inventors: HOU-HSIEN LEE, Tu-Cheng, Taipei Hsien (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/637,703

(22) Filed: Dec. 14, 2009

(30) Foreign Application Priority Data
Oct. 14, 2009 (CN) 200910308273.1

(51) Int. Cl. H04N 7/18; G06F 3/041; H04N 5/222

(52) U.S. Cl. 348/159; 345/173; 348/333.01; 348/E07.085

(57) ABSTRACT

A system is provided to control cameras of a camera array setup. The system generates an electric signal relative to a contacting track of a touching device on a touch screen. Therefore, a displacement of the touching device on the touch screen is obtained. The system generates a control signal. The control signal indicates a displacement range in which the displacement of the touching device is on the touch screen. The displacement range corresponds to a required camera of the camera array setup. The system controls the camera array setup to transmit video captured by the required camera to the touch screen. The video is displayed on the touch screen. The system can also switch the cameras of the camera array setup when a touch on the touch screen is sensed.

### BACKGROUND

1. Technical Field

The present disclosure relates to a system and a method for camera array control.

2. Description of Related Art

A camera array setup can be employed in a monitoring system to capture video. A camera array setup includes several cameras operating simultaneously. To select which one or more views of the cameras to display on a media player usually involves using keys or buttons to input commands which can be complex and hard for a user to memorize. To solve this problem, touch screens have been utilized. However, at this time the touch screens require users to accurately use graphical user interfaces which can slow down the selection of cameras and camera functions. This kind of operating procedure may not provide the best control needed in an environment where quick camera control is needed for security reasons.

### BRIEF DESCRIPTION OF THE DRAWINGS

FIG. 1 is a schematic block diagram of an embodiment of a controlling system for a camera array, the system includes an electronic device.

FIG. 2 is a schematic diagram of the electronic device of FIG. 1.

FIG. 3 is a schematic diagram of the camera array setup.

FIG. 4 is a flowchart of a first embodiment of a controlling method for the camera array setup of FIG. 3.

FIG. 5 is a flowchart of a second embodiment of a controlling method for the camera array setup of FIG. 3.

### DETAILED DESCRIPTION

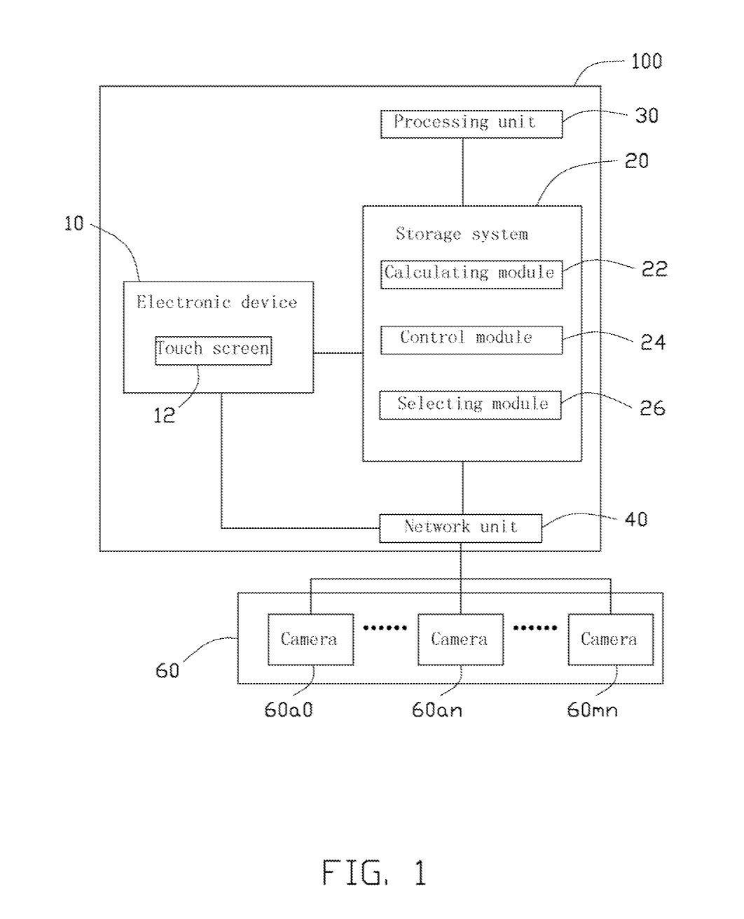

Referring to FIG. 1, an embodiment of a controlling system 100 for a camera array setup 60 includes an electronic device 10, a storage system 20, a processing unit 30, and a network unit 40. The electronic device 10 includes a touch screen 12. The camera array setup 60 may be used for security monitoring. The camera array setup 60 includes a plurality of cameras 60a0, 60a1 . . . , 60an . . . , 60mn. In this embodiment the cameras 60a0-60mn can shoot video simultaneously from different shooting angles. The system 100 is operable to select a current camera from the plurality of cameras 60a0-60mn. One of the cameras 60a0-60mn is selected by operating the touch screen 12 without guidance from a graphical user interface (GUI), that is no GUI, or on screen menu is used. The touch screen 12 can also display video captured by the current camera. In this embodiment, the electronic device 10 has a media player function. Simply put, a user can make camera selections and even function selections with simple touches and swiping gestures on the touch screen which lends itself to intuitive operation by a user and will be better suited to security environments where the camera array setup 60 is utilized. Commands (e.g. camera selection, pan, tilt) are associated with touches according to the nature (swipe or tap) and general location (e.g. upper left portion of screen) of touch.

The storage system 20 includes a calculating module 22, a control module 24, and a selecting module 26. The calculating module 22, the control module 24, and the selecting module 26 may include a plurality of computerized instructions and are executed by the processing unit 30.

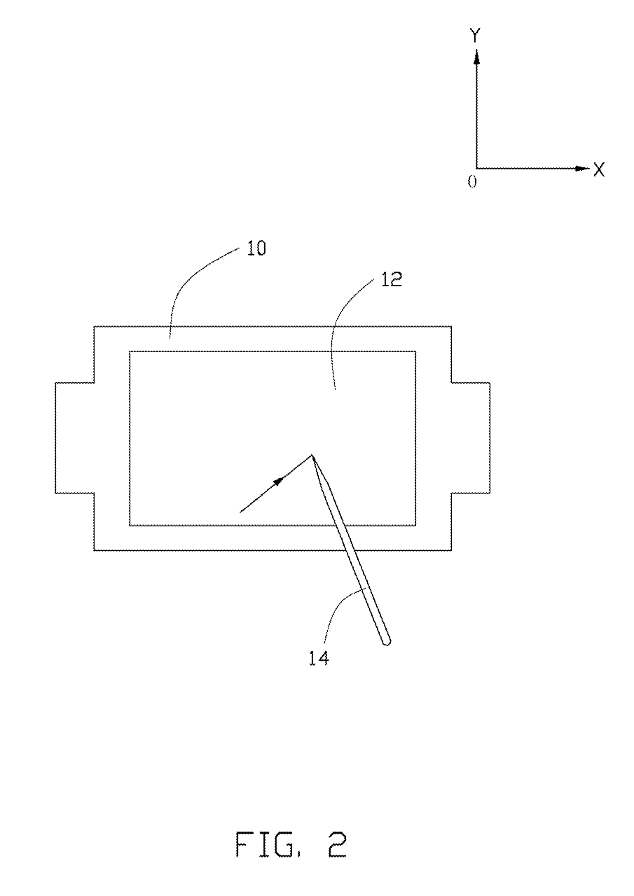

Referring to FIG. 2, the touch screen 12 of the electronic device 10 is a capacitive touch screen or a resistance touch screen. The touch screen 12 may be operated by a touching device 14. The touching device 14 may be a stylus or a finger of a user which, when moved around on the touch screen 12, functions as an input device of the electronic device 10. The touch screen 12 is capable of converting tracks and/or locations of contacts of the touching device 14 to electrical signals. A plane coordinate system may be defined on the touch screen 12, such as the XOY coordinate system as illustrated in FIG. 2.

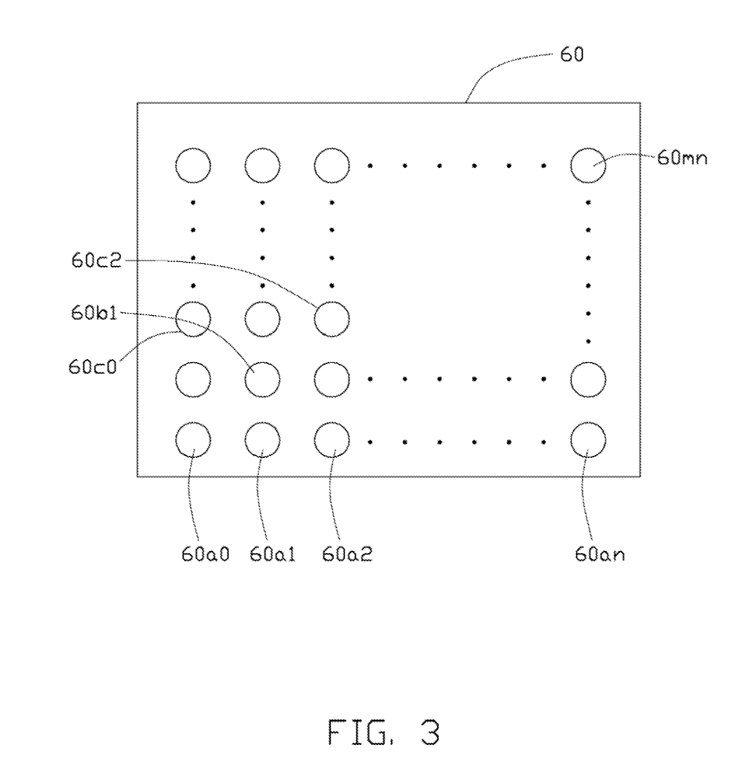

Referring to FIG. 3, in the illustrated embodiment, the plurality of cameras 60a0 . . . , 60an . . . , 60mn are arrayed in matrix in n rows and m lines. Any one of the plurality of cameras 60a01-60mn may be selected by the selecting module 26. In this embodiment, the camera 60a0 may be predetermined to be the current camera.

Commands or functions can be associated with each kind of track or touch. In a first embodiment, simple touches to the touch screen 12 that do not slide (static touches), correspond to camera selection according to location of the static touch. Whereas sliding touches are associated with pan and tilt commands for a current camera causing the camera to pan and/or tilt certain direction and magnitude according to direction and magnitude of the sliding touch of the touching device 14.

In the first embodiment, when the calculating module 22 receives an electric signal corresponding to a touch of the touching device 14 on a touch point of the touch screen 12, it calculates coordinates of the touch point according to the electric signal. The control module 24 receives the coordinates and outputs a first control signal accordingly. The first control signal indicates a coordinate range of the touch point. The selecting module 26 receives the first control signal.

The coordinate range includes a horizontal axis (X axis) distance range and an ordinate axis (Y axis) distance range. For example, a coordinate range may be depressed as (0-2 units, 2-4 units) or ((−2)-0 units, 0-2 units). Each unit of distance may be a length value, such as 1 centimeters (cm), corresponding to a distance between the touch point and the origin O of the plane coordinate system, such as 1.5 cm. The origin O of the plane coordinate system may be the center of the touch screen 12. A coordinate range ((−2)-2 units, (−2)-2 units) may correspond to the predetermined camera 60a0. If, for example, the coordinates of the touch point is in the range of ((−2)-2 units, (−2)-2 units), then the selecting module 26 will not change from the current camera to another. That is, if a distance between the touch point and the center of the touch screen 12 is less than 2 units, the selecting module 26 will not change from the current camera to another. If the coordinates of the touch point are in a range of (0-2 units, 4-6 units), the camera 60c0 which is in the first line and third row, is selected. If the coordinates of the touch point are in a range of (2-4 units, 2-4 units), the camera 60b1 aligned in the second line and the second row is selected. The video currently being shot by the selected camera is transmitted to the touch screen 12 by the network unit 40, and displayed on the touch screen 12. Therefore, a GUI is not needed to make camera selections. Speed of operating the system 100 to select a camera is relatively very fast.

The calculating module 22 may also receive an electric signal corresponding to a track of contact of the touching device 14 from the touch screen 12, and calculates a displacement of the touching device 14 on the touch screen 12 according to the electric signal. The displacement includes a distance and a direction that the touching device 14 moves. When the touching device 14 moves two units of distance along a 45 degrees direction from a point of the touch screen 12, the calculating module 22 obtains a displacement of the touching device 14 which is described as (2 units, 45 degrees). When the touching device 14 moves one unit of distance along a −45 degrees direction from a point of the touch screen 12, the displacement of the touching device 14 is described as (1 unit, −45 degrees). Each unit of distance may be a length value, such as 1 centimeter (cm). When the touching device 14 moves one unit of distance along the X direction from a point of the touch screen 12, the displacement of the touching device 14 is expressed as (1 unit, 0 degrees).

The control module 24 receives the displacement of the touching device 14 and outputs a second control signal accordingly. The network unit 40 transmits the second control signal to the camera array setup 60. The camera array setup 60 adjusts the parameters of the selected camera according to the second control signal. For example, the camera array setup 60 may pan the selected camera a required distance along a direction corresponding to the displacement of the touching device 14. For example, the camera array setup 60 moves the selected camera 3cm to the left if the displacement of the touching device 14 is 2 units at 180 degrees. Therefore, the selected camera can be quickly and easily redirected to aim at other areas without manual adjustment of the selected camera and without use of a GUI.

In a second embodiment, sliding touches are corresponding to camera selections. Whereas static touches are associated with pan and tilt commands.

In the second embodiment, when the calculating module 22 receives an electric signal corresponding to the track of contact of the touching device 14 from the touch screen 12. The control module 24 outputs a third control signal according to the displacement of the touching device 14 on the touch screen 12. The third control signal indicates a displacement range of the touching device. The selecting unit 26 selects one of the plurality of cameras 60a0-60mn according to a corresponding displacement range of the touching device 14.

The displacement range includes a distance range and a direction range. The distance range determines which line of cameras will be selected. The direction range determines which row of cameras will be selected. For example, if the displacement of the touching device 14 is in a range of (0-2 units, 0-30 degrees), then the selecting module 26 will not change from the current camera to another. If the displacement of the touching device 14 is in a range of (0-2 units, 30-60 degrees), the camera 60b1 which is in the first line and second row, is selected. If the displacement of the touching device 14 is in a range of (6-8 units, 60-90 degrees), the camera aligned in the third line and the third row is selected. Therefore, a GUI is not needed.

When the calculating module 22 receives an electric signal corresponding to the touch of the touching device 14 on the touch screen 12, the control module 24 outputs a fourth control signal according to the coordinate of the touch point. The fourth control signal indicates a coordinate range. The network unit 40 transmits the fourth control signal to the camera array setup 60. The camera array setup 60 adjusts parameters of the current camera according to the fourth control signal. For example, the camera array setup 60 may tilt the current camera an angle of 30 degrees if the coordinate of the touch point is (2 unit, 2 units) or in a range of (0-3 units, 0-3 units), as predefined by a user. The camera array setup 60 may also vary the focal length of the current camera if the coordinate of the touch point is changed in a range of ((−5)-0 units, (−10)-10 units). Therefore, parameters of the current camera can be controlled without manual adjustment of the camera array setup 60 and the GUI.

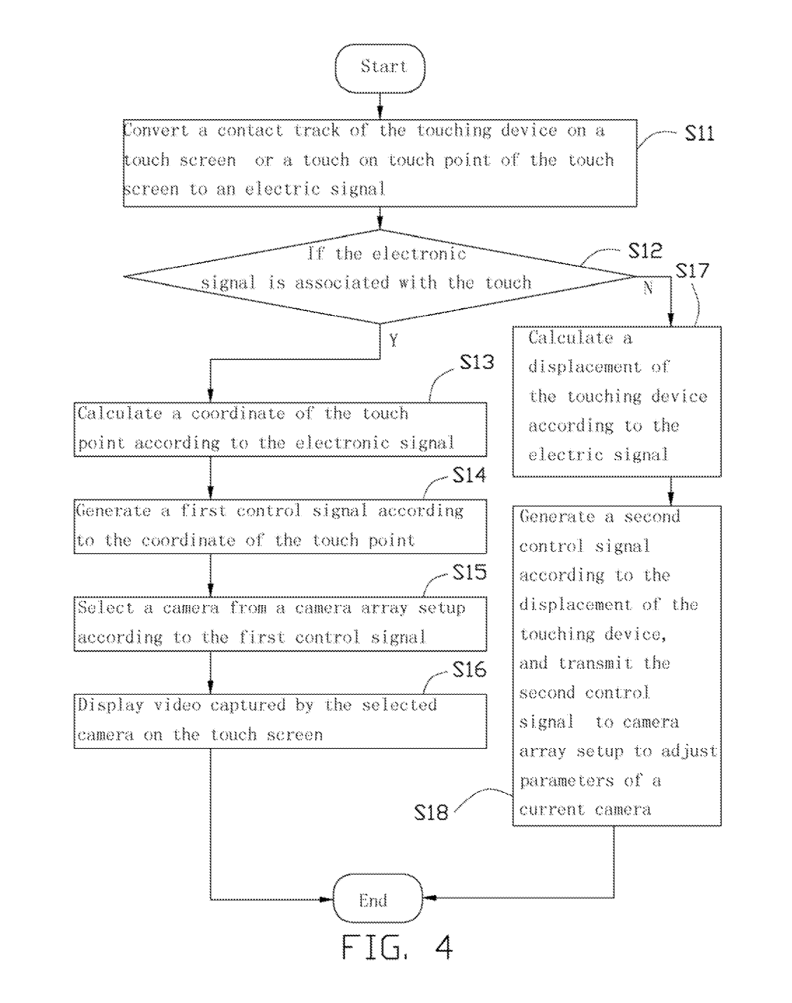

Referring to FIG. 4, a first embodiment of a method for switching the cameras 60a0-60mn of the camera array setup 60 includes the following steps.

In step S11, the touch screen 12 converts a contact track of the touching device 14 on the touch screen 12 or a touch on a touch point on the touch screen 12 to an electric signal. The electric signal is independent of GUI's. The electronic signal is transmitted to the calculating module 22.

In step S12, the calculating module 22 judges if the electronic signal is associated with the touch. If the electronic signal is associated with the touch, step S13 as detailed below is executed. If the electronic signal is not associated with the touch, it is associated with the contact track, then step S17 as detailed below is executed.

In step S13, the calculating module 22 calculates a coordinate of the touch point according to the received electronic signal.

In step S14, the control module 24 receives the coordinate of the touch point, and outputs the first control signal accordingly. The first control signal indicates a coordinate range. The coordinate of the touch point is in the coordinate range.

In step S15, the selecting module receives the first control signal, and selects a corresponding camera from the camera array setup 60. The selected camera is the current camera.

In step S16, video captured by the selected camera is transmitted to the touch screen 12 via the network unit 40, and are displayed on the touch screen 12.

In step S17, the calculating module 22 calculates a displacement of the touching device 14 according to the electric signal. The displacement includes a distance and a direction that the touching device 14 moves along the touch screen 12.

In step S18, the control module 24 receives the displacement of the touching device 14, and outputs the second control signal accordingly. The second control signal is transmitted to the camera array setup 60 via the network unit 40, to adjust parameters of the current camera.

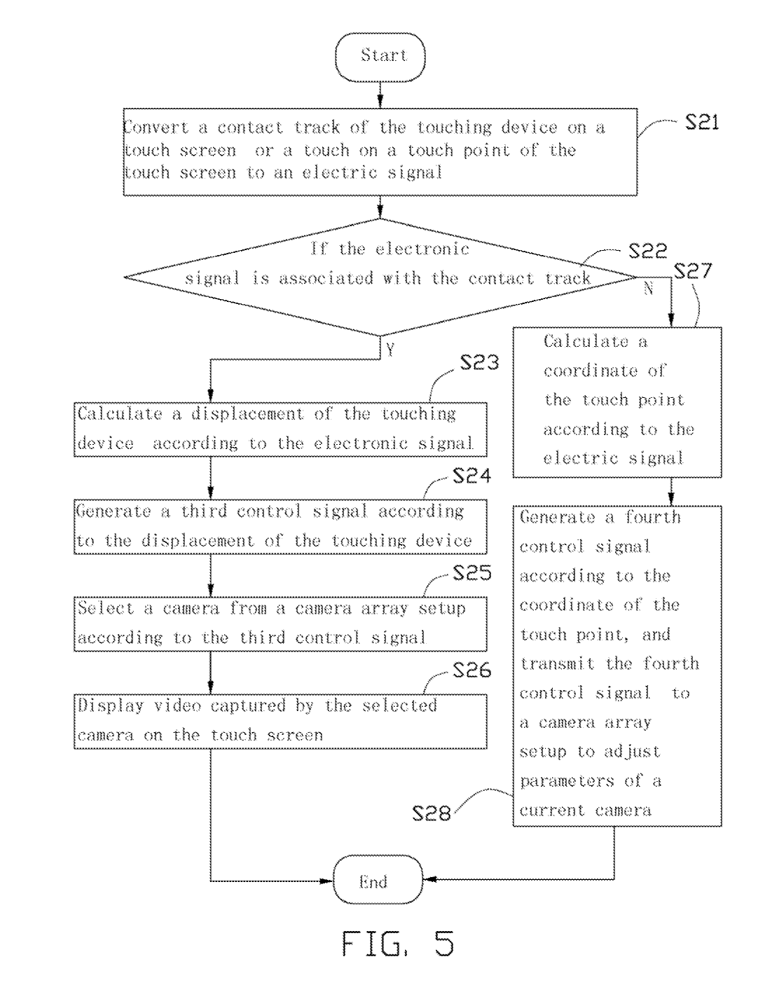

Referring to FIG. 5, a second embodiment of a method for switching cameras of the camera array setup 60 includes the following steps.

In step S21, the touch screen 12 converts a contact track of the touching device 14 on the touch screen 12 or a touch on a touch point on the touch screen 12 to an electric signal. The electronic signal is independent of GUI's, and is transmitted to the calculating module 22.

In step S22, the calculating module 22 judges if the electronic signal is associated with the contact track. If the electronic signal is associated with the contact track, step S23 as detailed below is executed. If the electronic signal is not associated with the contact track, it is associated with the touch, then, step S27 as detailed below is executed.

In step S23, the calculating module 22 calculates a displacement of the touching device 14 according to the electric signal.

In step S24, the control module 24 receives the displacement of the touching device 14, and outputs the third control signal accordingly. The third control signal indicates a displacement range. The displacement of the touching device 14 is in the displacement range.

In step S25, the selecting module 26 receives the third control signal, and selects a corresponding camera from the camera array setup 60.

In step S26, video captured by the selected camera is transmitted to the touch screen 12 via the network unit 40, and are displayed on the touch screen 12.

In step S27, the calculating module 22 calculates a coordinate of the touch point according to the received electronic signal.

In step S28, the control module 24 receives the coordinate of the touch point, and generates the fourth control signal correspondingly. The network unuit transmits the fourth control signal to the camera array setup 60 to adjust parameters of the current camera.

It is understood that the system 100 can also be used to control cameras of other styles of camera array setups except the camera array setup 60. In the other styles of camera array setups, the cameras may be arrayed in circular, spherical, or other configurations.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A system for controlling cameras of a camera array setup during security monitoring, the system comprising:
an electronic device comprising a touch screen to convert a contacting track of a touching device on the touch screen into a first electric signal, or convert a touch on the touch screen into a second electric signal independent of a graphical user interface;
a processing unit;
a storage system connected to the processing unit and storing a plurality of modules to be executed by the processing unit, wherein the plurality of modules comprise:
a calculating module to obtain a displacement of the touching device on the touch screen in response to receipt of the first electric signal, or to obtain coordinates of the touch on the touch screen in response to receipt of the second electric signal;
a control module to output a first control signal indicating a displacement range of the displacement of the touching device on the touch screen, or a second control signal indicating a coordinate range of the coordinate of the touch on the touch; and
a selecting module to select a corresponding camera of the camera array setup when signaled by the control module, wherein video captured by the selected camera is displayed on the touch screen.

2. The system of claim 1, wherein the displacement of the touching device comprises a distance and a direction that the touching device moves along the touch screen.

3. The system of claim 1, wherein the displacement range comprises a distance range and a direction range on the touch screen.

4. The system of claim 1, wherein the coordinate range comprises a horizontal distance range and an ordinate distance range between the touch point and a center of the touch screen.

5. The system of claim 1, further comprising a network unit to communicate the storage system and the camera array setup.

6. A system for controlling cameras of a camera array setup during security monitoring, the system comprising:
an electronic device comprising a touch screen to display video of a current camera of the camera array setup, convert one of a contacting track of a touching device on the touch screen and a touch on a touch point of the touch screen into first electric signal, and convert the other one of the contacting track and the touch of the touching device on the touch screen into a second electric signal, the first and second electronic signals are independent of graphical user interfaces;
a processing unit;
a storage system connected to the processing unit and storing a plurality of modules to be executed by the processing unit, wherein the plurality of modules comprise:
a calculating module to receive the first or second electronic signals, and calculating a displacement of the touching device in response to the received electronic signal being associated with the contacting touch, or obtain a coordinate of the touch point on the touch screen in response to the received electric signal being associated with the touch;
a control module to output a first control signal in response to receipt of the displacement of the touching device, or output a second control signal in response to receipt of the coordinate of the touch point, the second control signal is transmitted to the camera array setup to adjust parameters of the current camera; and
a selecting module to select a corresponding camera of the camera array setup to be the current camera, in response to receipt of the first control signal.

7. The system of claim 6, wherein the displacement of the touching device comprises a distance and a direction that the touching device moves along.

8. The system of claim 6, wherein the first control signal indicates a displacement range, the displacement of the touching device is in the displacement range.

9. The system of claim 6, wherein the second control signal indicates a coordinate range, the coordinate of the touch point is in a range of the coordinate range.

10. The system of claim 9, wherein the coordinate range comprises a horizontal distance range and an ordinate distance range between the touch point and a center of the touch screen.

11. The system of claim 6, further comprising a network unit connected between the storage system and the camera array setup.

12. A method for controlling cameras of a camera array setup, the method comprising:
generating an electric signal relative to a contacting track of a touching device on a touch screen or a touch on the touch screen, wherein the electric signal is independent of a graphical user interface;
processing the electric signal to obtain a displacement of the touching device on the touch screen or coordinates of the touch on the touch screen;
obtaining a first control signal indicating a corresponding range of one of the displacement of the touching device and the coordinate of the touch;
selecting a corresponding camera of the camera array setup to be a current camera according to the first control signal; and
displaying video captured by the current camera on the touch screen.

13. The method of claim 12, further comprising:
obtaining a second control signal according to the other one of the displacement of the touching device and the coordinates of the touch; and
adjusting parameters of the current camera according to the second control signal.
